(19) United States
(12) Patent Application Publication
(10) Pub. No.: US 2007/0132910 A1
(43) Pub. Date: Jun. 14, 2007

(54) DISPLAY DEVICE WITH LIGHT SHADING ABILITY

(75) Inventor: Fang Yu Liao, Taipei City (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/609,292

(22) Filed: Dec. 11, 2006

(30) Foreign Application Priority Data
Dec. 12, 2005 (TW) TW94143816

(51) Int. Cl. G02F 1/1333

(52) U.S. Cl. 349/58

(57) ABSTRACT

Display devices with light shading ability are provided. An exemplary embodiment of a display device with light shading ability includes a housing, a display unit, and a light shade. The display unit is disposed in the housing. The light-shading assembly is detachably disposed on the housing by a magnetic force. Thus, the display unit is shielded from partial illumination by environmental light.

### BACKGROUND

The invention relates to a display device, and in particular to a display device with light shading ability.

Display devices are applied in PCs, digital cameras, and other electronic devices. When a display device is exposed to sun light or intense illumination, images displayed thereon are difficult to see without a light shading device.

In general, a light-shading mask is adhesively attached to or hooked on a housing of a display device. To prevent the housing from being damaged, the light-shading mask must be carefully detached from the housing.

### SUMMARY

The invention provides a display device with light shading ability. The display device comprises a housing, a display unit, and a light shade. The display unit is disposed in the housing. The light-shading assembly is detachably disposed on the housing by a magnetic force. Thus, the display unit is shielded from partial illumination by environmental light.

### DESCRIPTION OF THE DRAWINGS

The invention can be more fully understood by reading the subsequent detailed description and examples with references made to the accompanying drawings, wherein:

FIG. 1a is a perspective view of a digital camera of a first embodiment of the invention, wherein the digital camera comprises a display device having a housing and a light-shading assembly separated from the housing.

FIG. 1b is a perspective view of a digital camera of a first embodiment of the invention, wherein the digital camera comprises a display device having a housing and a light-shading assembly connected to the housing.

FIG. 1c is a perspective view of a display device having a housing and a light-shading assembly separated from the housing.

FIG. 1d is an exploded view of a display device of FIG. 1c.

FIG. 1e is a perspective view of a light-shading assembly of FIG. 1a, wherein the light-shading assembly comprises a plurality of positioning posts.

FIG. 2a is a perspective view of a digital camera of a second embodiment of the invention, wherein the digital camera comprises a display device having a housing and a light-shading assembly separated from the housing.

FIG. 2b is a perspective view of a digital camera of a second embodiment of the invention, wherein the digital camera comprises a display device having a housing and a light-shading assembly connected to the housing.

FIG. 2c is a perspective view of a light-shading assembly of FIG. 2a, wherein the light-shading assembly comprises a plurality of positioning posts.

### DETAILED DESCRIPTION

The invention features a light-shading assembly that can be magnetically disposed on a housing of a display device.

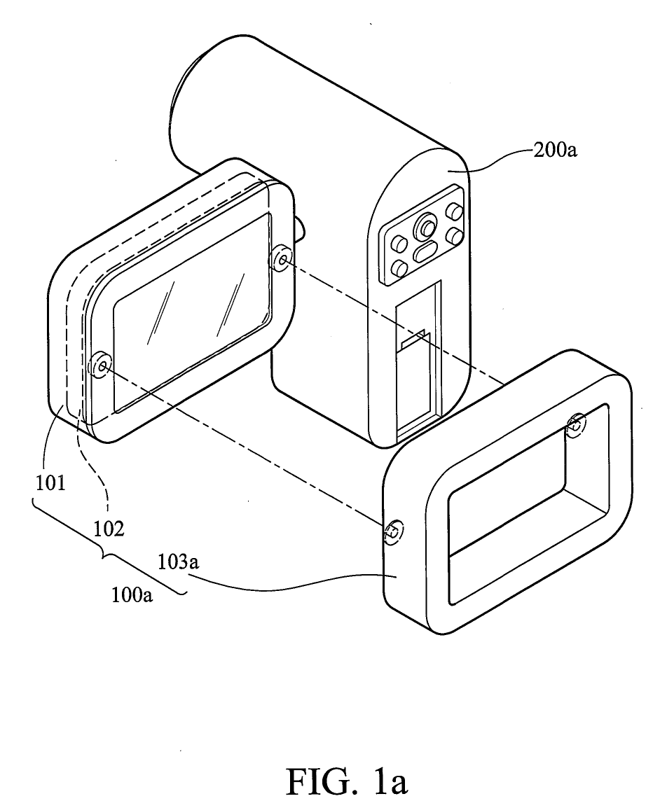

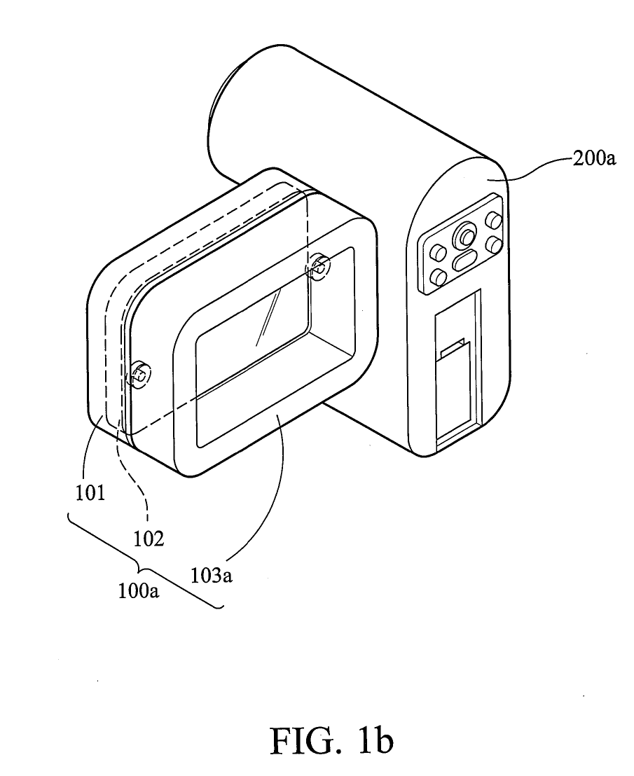

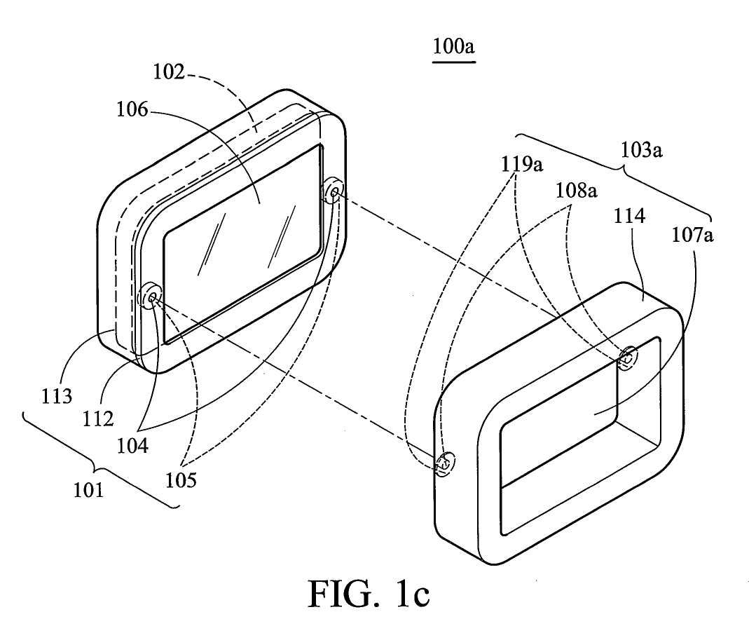

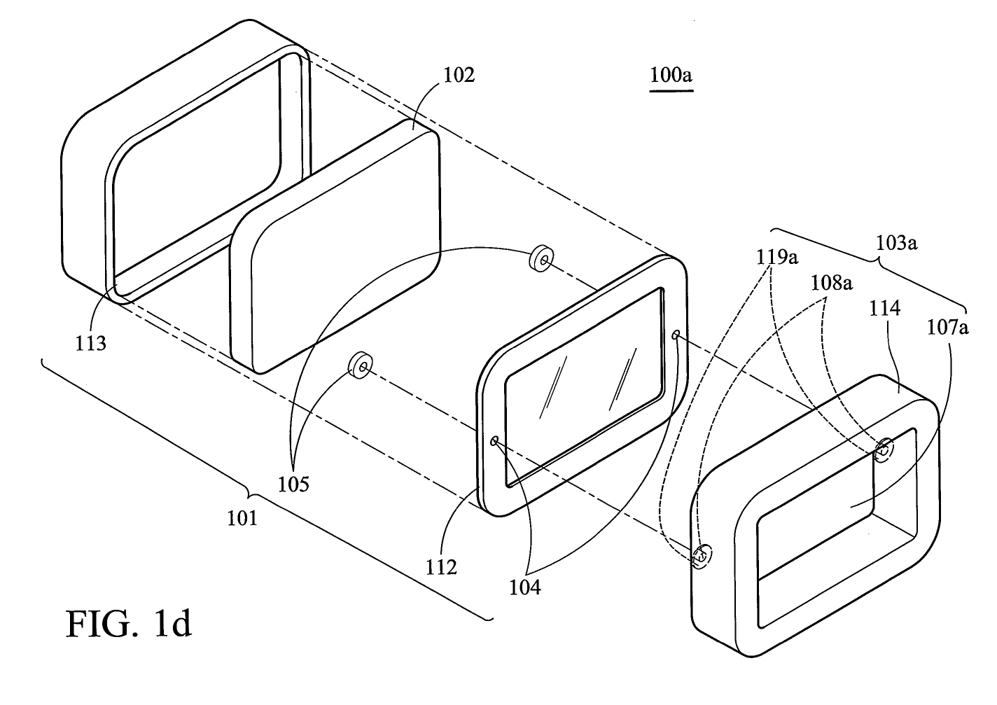

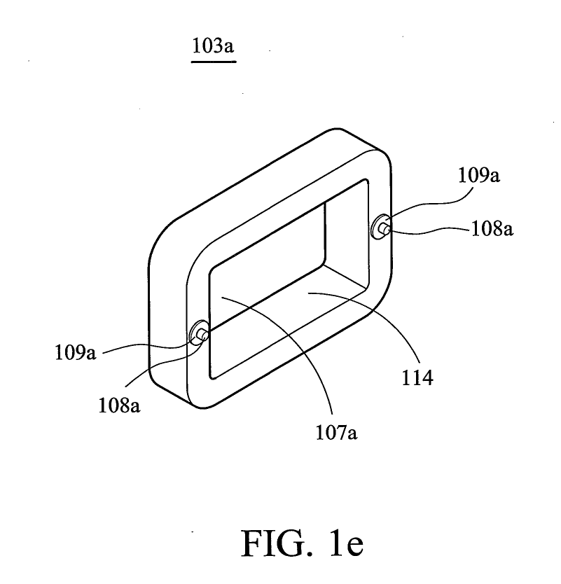

In FIGS. 1a and 1b, the digital camera 1 of a first embodiment of the invention comprises a host 200a and a display device 100a connected to the host 200a. The display device 100a comprises a housing 101, a display unit 102 and a light-shading assembly 103a. The display unit 102 is disposed in the housing 101, and the light-shading assembly 103a and 103b is magnetically disposed on the housing 101. In FIG. 1a, the light-shading assembly 103a is separated from the housing 101. In FIG. 1b, the light-shading assembly 103a is connected to the housing 101.

In FIGS. 1c, 1d and 1e, a housing 101 comprises a front cover 112, a rear cover 113 connected to the front cover 112, a positioning hole 104 formed on the front cover 112, and a magnet 105 adhesively attached to the front cover 112 and placed next to the positioning hole 104. In this embodiment, the front cover 112 and the rear cover 113 are made of plastic, and the display unit 102 is a liquid crystal display unit.

When the front cover 112 and the rear cover 113 are connected to each other, the display unit 102 can be fixed therebetween, i.e., the display unit 102 is partially covered by the housing 101 to form an exposed display area 106.

The light-shading assembly 103a comprises a body 114, an opening 107a, a positioning post 108a corresponding to the positioning hole 104 of the housing 101, and a magnetic structure 109a corresponding to the magnet 105 of the housing 101. The light-shading assembly 103a is disposed on the housing 101 along a periphery of the exposed display area 106, and the opening 107a of the light-shading assembly 103a does not overlap the exposed display area 106. In this embodiment, the body 114 is made of plastic, and the magnetic structure 109a is a metallic sheet.

When the magnetic structure 109a and the magnet 105 are mutually attracted, a magnetic force is formed to magnetically dispose the light-shading assembly 103a on the housing 101. When the light-shading assembly 103a is disposed on the housing 101, the positioning post 108a is inserted into the positioning hole 104.

Thus, the light-shading assembly 103a disposed on the housing 101 can prevent the display unit 102 from being illuminated by environmental light. Additionally, light from different directions of the environment can be blocked by the rectangular light-shading assembly 103a.

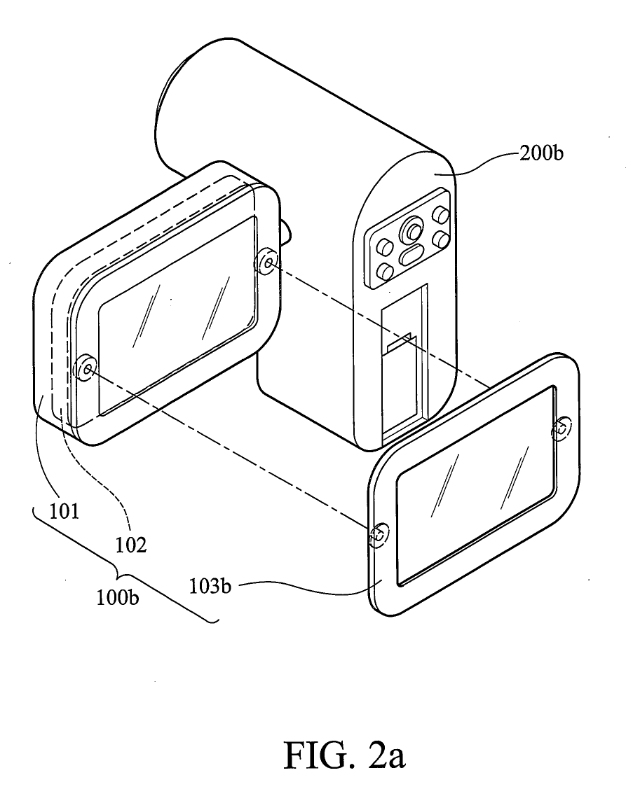

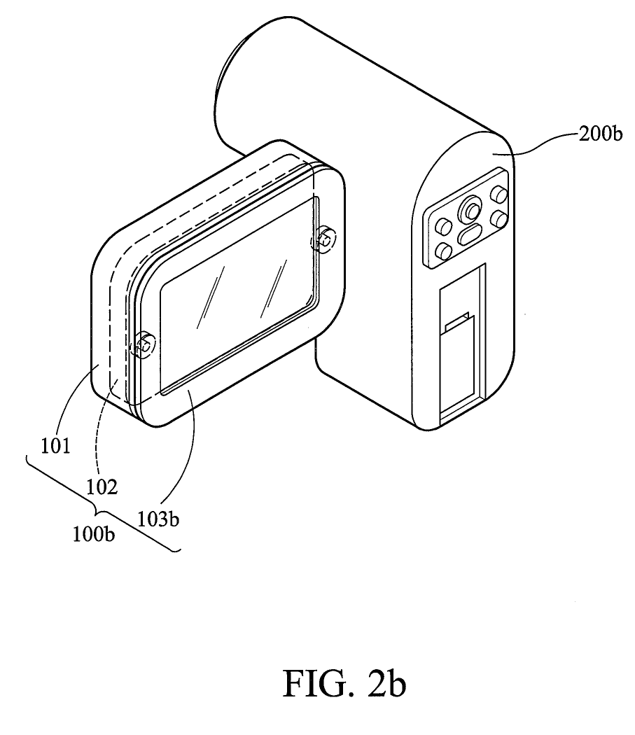

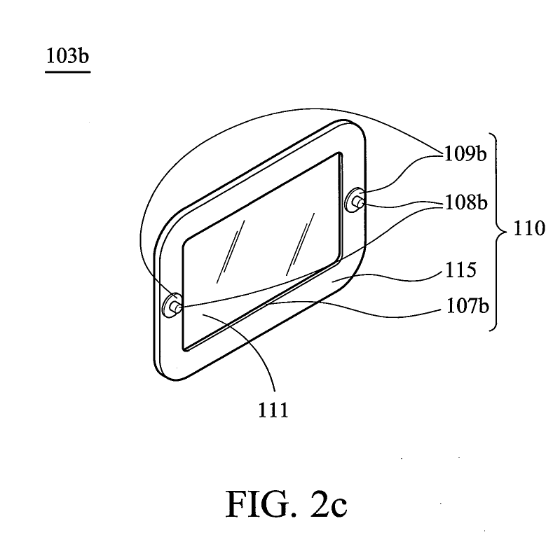

In FIGS. 2a, 2b and 2c, the digital camera 2 of a second embodiment of the invention comprises a host 200b and a display device 100b connected to the host 200b. The display device 100b comprises a housing 101, a display unit 102 and a light-shading assembly 103b.

The digital camera 2 differs from the digital camera 1 of the first embodiment in that the light-shading assembly 103b comprises a frame 110 and a light-shading sheet 111.

The frame 110 comprises a body 115, an opening 107b, a positioning post 108b corresponding to the positioning hole 104 of the housing 101, and a magnetic structure 109b corresponding to the magnet 105 of the housing 101. The light-shading assembly 103b is disposed on the housing 101 along a periphery of the exposed display area 106, and the opening 107b of the light-shading assembly 103a and 103b does not overlap the exposed display area 106. Due to the area of the shading sheet 111 substantially equal to that of the exposed display area 106, the display unit 102 is shield from illumination by environmental light. In this embodiment, the body 115 of the frame 110 is made of plastic.

When the magnetic structure 109b and the magnet 105 are mutually attracted, a magnetic force is formed to magnetically dispose the frame 110 on the housing 101. Thus, the light-shading assembly 103b can be magnetically mounted on or detached from the frame 110, and the light-shading assembly 103b is positioned at the desired position when the positioning post 108b is inserted in the positioning hole 104 of the housing 101.

It is to be understood that the invention is not limited to the disclosed light-shading assembly, but, on the contrary, is intended to cover various modifications and equivalent mechanisms or devices. The light-shading assembly can be magnetically mounted on or detached from the housing. The light-shading assembly and the housing have simple structures, thus, decreasing cost and actual space required for assembly.

Additionally, the light-shading assembly is substantially rectangular, thus, light from different directions can be blocked. The light-shading assembly is directly fixed on the housing of the display device, thus, the light-shading assembly is not affected when the display device is moved or turned to a predetermined position or angle.

While the invention has been described with respect to preferred embodiment, it is to be understood that the invention is not limited thereto, but, on the contrary, is intended to accommodate various modifications and equivalent arrangements included within the spirit and scope of the appended claims.

What is claimed is:

1. A display device with light shading ability, comprising:
a housing;
a display unit disposed in the housing; and
a light-shading assembly magnetically disposed on the housing to prevent the display unit from being illuminated by environmental light.

2. The display device with light shading ability as claimed in claim 1, wherein the display unit comprises a liquid crystal display unit.

3. The display device with light shading ability as claimed in claim 1, wherein the light-shading assembly comprises a plastic piece.

4. The display device with light shading ability as claimed in claim 1, wherein the display unit comprises an exposed display area and the light-shading assembly comprises an opening, wherein the display unit is partially covered by the housing, the light-shading assembly is disposed on the housing along a periphery of the exposed display area, and the opening of the light-shading assembly does not overlap the exposed display area.

5. The display device with light shading ability as claimed in claim 1, wherein the light-shading assembly comprises a positioning post and the housing comprises a positioning hole corresponding to the positioning post, wherein the positioning post is inserted into the positioning hole when the light-shading assembly is disposed on the housing.

6. The display device with light shading ability as claimed in claim 1, wherein the light-shading assembly comprises a magnetic structure and the housing comprises a magnet corresponding to the magnetic structure, wherein a magnetic force is formed when the magnetic structure and the magnet are mutually attracted.

7. The display device with light shading ability as claimed in claim 6, wherein the magnetic structure comprises a metallic sheet.

8. The display device with light shading ability as claimed in claim 1, wherein the light-shading assembly comprises a frame magnetically disposed on the housing and a light-shading sheet disposed on the frame to prevent the display unit from being illuminated by environmental light.

9. The display device with light shading ability as claimed in claim 8, wherein the frame comprises a plastic.

10. The display device with light shading ability as claimed in claim 8, wherein the display unit comprises an exposed display area and the light-shading assembly comprises an opening, wherein the display unit is partially covered by the housing, the light-shading assembly is disposed on the housing along a periphery of the exposed display area, and the opening of the light-shading assembly does not substantially overlap the exposed display area.

11. The display device with light shading ability as claimed in claim 10, wherein the area of the shading sheet is substantially equal to that of the exposed display area.
